(19) United States
(12) Patent Application Publication
(10) Pub. No.: US 2026/0117643 A1
(43) Pub. Date: Apr. 30, 2026

(54) TUBING HANGER LOCKDOWN ELEVATION MEASUREMENT TOOL

(71) Applicant: OneSubsea IP UK Limited, London (GB)

(72) Inventor: Jonathan Mark Frankland, Leeds (GB)

(21) Appl. No.: 19/374,258

(22) Filed: Oct. 30, 2025

Related U.S. Application Data
(60) Provisional application No. 63/713,952, filed on Oct. 30, 2024.

(51) Int. Cl. E21B 47/09; E21B 33/04; G01S 15/08; G01S 17/08

(52) U.S. Cl. CPC E21B 47/09; E21B 33/04; G01S 15/08; G01S 17/08

(57) ABSTRACT

A system includes a downhole tool configured to run into a wellhead of a resource extraction system. The downhole tool includes a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation. The downhole tool further includes one or more additional tools configured to perform one or more additional operations in the wellhead, a blowout preventer (BOP) coupled to the wellhead, or a combination thereof.

### CROSS-REFERENCE TO RELATED APPLICATION

This application claims benefit to U.S. Provisional Patent Application No. 63/713,952, filed on Oct. 30, 2024, which is hereby incorporated by reference in its entirety for all purposes.

### BACKGROUND

The present disclosure relates generally to a measurement tool for measuring an installation site prior to installation of a tubing hanger in a wellhead.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

To meet consumer and industrial demand for natural resources, companies search for and extract oil, natural gas, and other subterranean resources from the earth. Once a desired subterranean resource is discovered, drilling and production systems are employed to access and extract the desired subterranean resource. The drilling and production systems may be located onshore or offshore depending on the location of the desired subterranean resource. In subsea oil production, installation of a lower completion is conducted prior to installing an upper completion for a tubing hanger in a wellhead, after the drilling of a wellbore. The tubing hanger may be used to suspend a string (e.g., piping for a flow in and/or out of a well). Prior to installing the tubing hanger within the wellhead, an elevation (e.g., distance) between a landing shoulder of the tubing hanger and a lockdown mechanism of the tubing hanger is adjusted with regard to a location of lockdown grooves (e.g., annular grooves) disposed on an interior housing (e.g., high pressure housing) of the wellhead. The lockdown mechanism of the tubing hanger may securely lock with the lockdown grooves to secure a position of the tubing hanger in the wellhead.

For this purpose, a lead impression tool (LIT) may be deployed via a drill pipe to provide a measurement of the elevation from an uppermost casing hanger to the lockdown grooves for adjusting the tubing hanger for prepping the tubing hanger to be installed as part of the upper completion. The LIT may include a lead impression component that may take impressions of the lockdown grooves. Typically, the deployment of the LIT requires a dedicated trip, which increases the downtime of the well and increases operational expenses. In some instances, the lead impression component of the LIT may include unclear impressions of the lockdown grooves, and the LIT may be re-deployed within the wellhead. With this in mind, determining the location of the lockdown grooves within the wellhead may not be efficient with regards to costs and time.

### SUMMARY

Certain embodiments commensurate in scope with the originally filed claims are summarized below. These embodiments are not intended to limit the scope of the present technology, but rather these embodiments are intended only to provide a brief summary of possible forms of the technology. Indeed, the present system and method may encompass a variety of forms that may be similar to or different from the embodiments set forth below.

In certain embodiments, a system includes a downhole tool configured to run into a wellhead of a resource extraction system. The downhole tool includes a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation. The downhole tool further includes one or more additional tools configured to perform one or more additional operations in the wellhead, a blowout preventer (BOP) coupled to the wellhead, or a combination thereof

In certain embodiments, a method includes running a downhole tool into a wellhead of a resource extraction system. The method further includes operating a lockdown elevation measurement tool of the downhole tool to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation. The method further includes operating one or more additional tools of the downhole tool to perform one or more additional operations in the wellhead, a blowout preventer (BOP) coupled to the wellhead, or a combination thereof.

In certain embodiments, a system includes a downhole tool configured to run into a wellhead of a resource extraction system. The downhole tool includes a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation, wherein the lockdown elevation measurement tool includes a non-contact tool having one or more measurement devices configured to obtain the one or more measurements indicative of the location to determine a distance from the uppermost casing hanger to the one or more lockdown grooves. The downhole tool further includes a controller having a processor, a memory, and instructions stored on the memory and executable by the processor to receive measurement data of the one or more measurements indicative of the location of the one or more lockdown grooves, and determine the distance based on the measurement data.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a resource extraction system, in accordance with an embodiment of the present disclosure;

FIG. 2 is a schematic side view of a lockdown elevation measurement tool integrated with a plurality of additional tools deployed in the resource extraction system of FIG. 1, in accordance with an embodiment of the present disclosure;

FIG. 3 is a schematic top view of the lockdown elevation measurement tool of FIG. 2, in accordance with an embodiment of the present disclosure;

FIG. 4 is a schematic side view of the lockdown elevation measurement tool of FIGS. 2 and 3 integrated with a casing hanger seal assembly running tool (CHSART), in accordance with an embodiment of the present disclosure;

FIG. 5 is a schematic side view of the lockdown elevation measurement tool of FIGS. 2 and 3 integrated with a blowout preventer (BOP) tool and a wear bushing tool, in accordance with an embodiment of the present disclosure; and

FIG. 6 is a schematic side view of the lockdown elevation measurement tool of FIGS. 2 and 3 as a standalone tool deployed in the resource extraction system of FIG. 1, in accordance with an embodiment of the present disclosure.

### DETAILED DESCRIPTION

Certain embodiments commensurate in scope with the present disclosure area summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

In the present context, the term “about” or “approximately” is intended to mean that the values indicated are not exact and that the actual value may vary from those indicated in a manner that does not materially alter the operation concerned. For example, the term “about” or “approximately” as used herein is intended to convey a suitable value that is within a particular tolerance (e.g., ±10%, ±5%, ±1%, ±0.5%), as would be understood by one skilled in the art.

With the foregoing in mind, the present disclosure relates to a lockdown elevation measurement tool directed towards improving methods in measuring the location of the lockdown grooves (e.g., annular grooves) disposed on the interior housing of the wellhead. As mentioned earlier, the elevation (e.g., distance) between the landing shoulder of the tubing hanger and the lockdown mechanism of the tubing shoulder may be adjusted based on the location of the lockdown grooves disposed on the housing of the wellhead to enable proper locking between the tubing hanger and the housing of the wellhead. Accordingly, in some embodiments described herein, the lockdown elevation measurement tool may be installed (e.g., incorporated) with different tools and may include an additional measuring component to determine the location of the lockdown grooves on the wellhead. As a result, the lockdown elevation measurement tool reduces the total cost of the drilling process and the total time of the drilling process by minimizing the number of tools deployed within the wellhead and improving the likelihood of accurately measuring the location of the lockdown grooves within the wellhead.

In some embodiments, the lockdown elevation measurement tool may include a measuring component that may include a mechanical contact tool, a non-contact tool, or both. As earlier described, the contact tool may include a lead impression component that may take an impression of the lockdown grooves when the lockdown elevation measurement tool is deployed within the wellhead. The lockdown elevation measurement tool may also include a non-contact tool that may include a sensor device to measure the location of the lockdown grooves within the wellhead. The contact tool and the non-contact tool may be azimuthally (e.g., circumferentially) disposed on the lockdown elevation measurement tool. For example, the lockdown elevation measurement tool may include multiple lead impression components disposed azimuthally on the lockdown elevation measurement tool, multiple sensor devices disposed azimuthally on the lockdown elevation measurement tool, or multiple lead impression components and multiple sensor devices alternatively disposed azimuthally on the lockdown elevation measurement tool.

In some embodiments, the lockdown elevation measurement tool may be installed (e.g., included) on different tools of the drilling process. For example, the lockdown elevation measurement tool may be integrated with a wear bushing tool used to install a wear bushing in casing hangers, a casing hanger seal assembly running tool (CHSART) used to install casing hangers and associated seal assemblies, and/or a blowout preventer (BOP) test tool used to perform various tests (e.g., pressure tests, seal tests, etc.) on a BOP. That is, the lockdown elevation measurement tool may be coupled (e.g., installed) to a main tool (e.g., other tool used during a wellhead assembly process), and while the main tool is operating within the wellhead, the lockdown elevation measurement tool may concurrently determine the location of the lockdown grooves disposed on the wellhead. Therefore, the lockdown elevation may reduce the total time and costs of the wellhead assembly process (e.g., as compared to a separate LIT individually deployed within the wellhead) and improve the accuracy of the measurement of the location of the lockdown grooves.

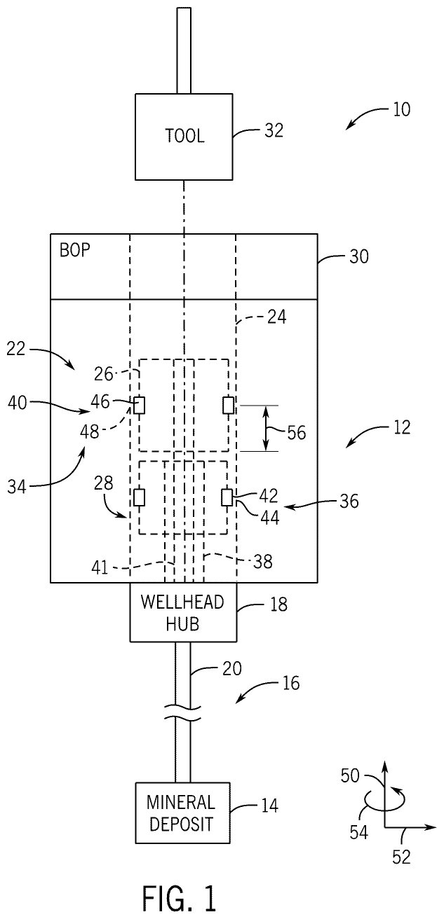

With the foregoing in mind, FIG. 1 is a block diagram of an embodiment of a resource extraction system 10. The resource extraction system 10 may be configured to extract various minerals and natural resources, including hydrocarbons (e.g., oil and/or natural gas), from the earth. Additionally or alternatively, the resource extraction system 10 may be configured to inject substances into the earth. The resource extraction system 10 may be land-based (e.g., a surface system) or subsea (e.g., a subsea system). As shown, the resource extraction system 10 includes a wellhead 12 coupled to a mineral deposit 14 via a well 16. The well 16 includes a wellhead hub 18 and a wellbore 20. The wellhead hub 18 may include a large diameter hub that is disposed at the termination of the wellbore 20. The wellhead hub 18 provides for the connection of the wellhead 12 to the well 16. The wellhead 12 includes a plurality of hangers 22 secured in an internal bore 24, wherein the hangers 22 may include a tubing hanger 26 disposed over one or more casing hangers 28. Additionally, the resource extraction system 10 may include a blowout preventer (BOP) 30 coupled to the wellhead 12 as a safety valve to prevent a blowout by sealing the wellbore 20. As discussed in detail below, the resource extraction system 10 includes one or more tools 32 (e.g., downhole tools) to obtain measurements at an installation site 34 for the hangers 22 (e.g., tubing hanger 26), install the hangers 22, install wearing bushings in the hangers 22, perform various tests (e.g., pressure tests, seal tests, etc.), and so forth. In particular, the embodiments described in detail below employ the tool 32 to obtain measurements at the installation site 34 alone or in combination with other tool functions.

In certain embodiments, one or more tools 32 install the hangers 22 in the internal bore 24. For example, the one or more tools 32 may lower and secure one or more casing hangers 28 in the internal bore 24 via a respective lock and seal assembly 36. Each casing hanger 28 may be configured to support and hang a respective casing string 38. By further example, the one or more tools 32 may lower and secure the tubing hanger 26 in the internal bore 24 via a respective lock and seal assembly 40. The tubing hanger 26 may be configured to support and hang a tubing string 41. The lock and seal assembly 36 of each casing hanger 28 may include a lock or locking mechanism 42 configured to engage a lockdown groove 44 (e.g., annular groove) in the internal bore 24. Similarly, the lock and seal assembly 40 of the tubing hanger 26 may include a lock or locking mechanism 46 configured to engage a lockdown groove 48 (e.g., annular groove) in the internal bore 24. The locking mechanisms 42 and 46 may include a lock ring (e.g., metal ring, C-shaped ring, segmented ring, etc.) and/or locking dogs configured to engage with the lockdown grooves 44 and 48 to block movement of the hangers 22 in the internal bore 24. Each of the lockdown grooves 44 and 48 may include a single annular groove or a plurality of annular grooves. The lock and seal assemblies 36 and 40 may further include one or more annular seals or packing assemblies configured to seal the hangers 22 in the internal bore 24.

During installation, the one or more tools 32 install the casing hangers 28 prior to installation of the tubing hanger 26. For purposes of discussion, the resource extraction system 10 and its components may be described with reference to an axial axis or direction 50, a radial axis or direction 52, and a circumferential axis or direction 54. The one or more tools 32 run the casing hangers 28 in the axial direction 50 into the internal bore 24, and perform operations to actuate the locking mechanism 42 and energize seals between the casing hangers 28 and the internal bore 24. The one or more tools 32 include a lockdown elevation tool, either as a standalone tool or as a combined tool integrated with other tools, for obtaining measurements at the installation site 34 prior to installation of the tubing hanger 26. The measurements may include a distance 56 (e.g., axial distance) between an uppermost casing hanger and the lockdown groove 48 for the locking mechanism 46 of the tubing hanger 26. The measurements may be used to adjust the one or more tools 32 to position the locking mechanism 46 at an appropriate position along the tubing hanger 26 prior to installation of the tubing hanger 26. After obtaining the measurements and making appropriate adjustments, the one or more tools 32 run the tubing hanger 26 in the axial direction 50 into the internal bore 24 and land the tubing hanger 26 on the uppermost casing hanger, and perform operations to actuate the locking mechanism 46 and energize seals between the tubing hanger 26 and the internal bore 24.

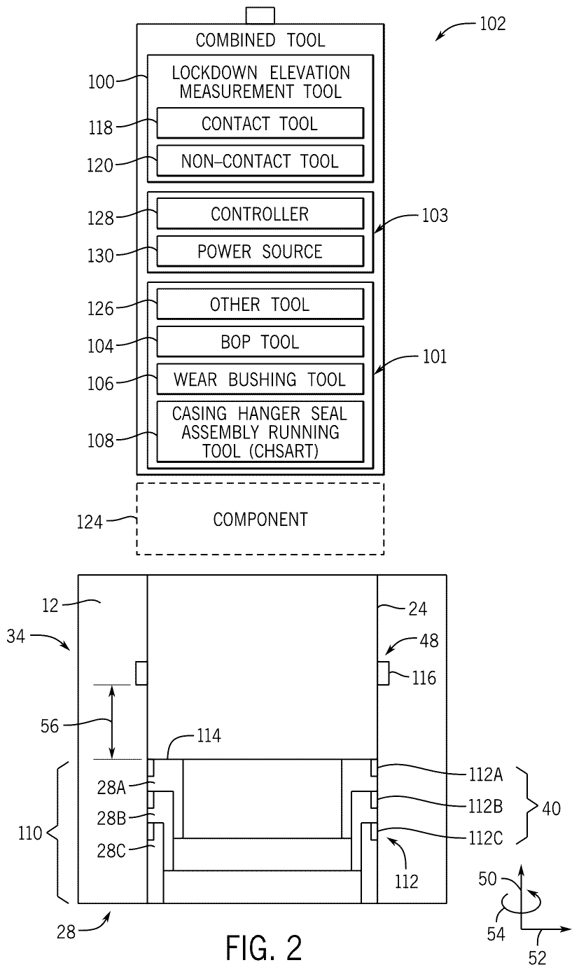

As discussed in detail below with reference to FIG. 2-6, the resource extraction system 10 may include a lockdown elevation tool to determine the distance 56 between the uppermost casing hanger and the lockdown groove 48 disposed on an interior housing (e.g., high pressure housing) of the wellhead 12. Unfortunately, the distance 56 may vary in different configurations and installations of casing hangers 28 in the wellhead 12, and thus the precise distance 56 may be unknown without taking any measurements with the lockdown elevation tool. The precise distance 56 helps to ensure proper alignment and engagement of the locking mechanism 46 of the tubing hanger 26 with the lockdown groove 48 in the wellhead 12. Thus, in some embodiments, the lockdown elevation measurement tool may include one or more types of measurement tools to accurately measure the distance 56 from the uppermost casing hanger to the lockdown groove 48 disposed within the wellhead 12. The measurement tools may include contact tools (e.g., mechanical tool that contacts the lockdown groove 48) and non-contact tools (e.g., optical measurement tools, inductive and magnetic measurement tools, wireless signal tools, imaging tools or cameras, etc.). For example, the mechanical tools may include a soft material (e.g., lead) that conforms to the surface of the lockdown groove 48. By further example, optical measurement tools may include light emitting and receiving tools, such as laser measurement tools and/or light detecting and ranging (LiDAR) tools.

FIG. 2 is a schematic side view of an embodiment of one of the tools 32 of FIG. 1, further illustrating a combined tool 102 (e.g., tool string) including the lockdown elevation measurement tool 100, a plurality of additional tools 101, and a power and control system 103 deployed in the resource extraction system 10. As mentioned above, the plurality of additional tools 101 of the combined tool 102 may include a blowout preventer (BOP) tool 104, a wear bushing tool 106, a casing hanger seal assembly running tool (CHSART) tool 108, and/or any suitable tool 126 deployed during the drilling process. The combined tool 102 may include any combination of the lockdown elevation measurement tool 100 with one or more additional tools 101. Thus, in operation, the combined tool 102 runs a single trip with the lockdown elevation measurement tool 100 and the additional tools 101, thereby enabling multiple tool operations in the single trip.

The formation of the wellbore 20 may include a drilling process, a lower completion process, and an upper completion process. The drilling process may include forming the wellbore 20 and installing casing to protect the wellbore 20 from outside sources and provide the wellbore 20 with structural integrity. Accordingly, the wellhead 12 supports a casing hanger assembly 110 to support and hang one or more casing strings in the wellbore 20. The casing hanger assembly 110 may include a plurality of casing hangers 28, such as casing hangers 28A, 28B, and 28C disposed in a concentric arrangement one over another. The casing hanger 28A corresponds to an uppermost casing hanger 114. Each casing hanger 28 may include a lock and seal assembly 40, 112 (e.g., 112A, 112B, and 112C) configured to lock and seal the respective casing hanger 28 (e.g., 28A, 28B, and 28C) to an interior surface of the wellhead 12 (e.g., the internal bore 24). As discussed above with reference to FIG. 1, each lock and seal assembly 40, 112 includes a locking mechanism and one or more annular seals or packing assemblies configured to seal the casing hanger 28 in the internal bore 24. The locking mechanism may include a lock ring (e.g., metal ring, C-shaped ring, segmented ring, etc.) and/or locking dogs configured to engage with corresponding lockdown grooves in the internal bore 24. In certain embodiments, the combined tool 102 includes the CHSART 108 configured to run in and install at least the uppermost casing hanger 28A, 114 along with its corresponding lock and seal assembly 112A, while also enabling other tool operations in the same trip. For example, along with the CHSART 108, the lockdown elevation measurement tool 100 may obtain one or more measurements at the installation site 34 prior to installation of the tubing hanger 26. The lower completion process includes preparing the wellbore 20 to enable hydrocarbons to flow into the well, while the uppermost completion process includes installing production tubing (e.g., tubing spool) to enable transportation of the hydrocarbons to the surface.

The production tubing (e.g., tubing spool) includes a tubing hanger 26 (see FIG. 1) that is configured to support a full weight of the tubing string within the wellhead 12. A landing shoulder of the tubing hanger 26 lands on an uppermost casing hanger 28, 114, and the tubing hanger 26 may include a locking mechanism (e.g., lock ring, metal ring, c-shaped ring) configured to lock with lockdown grooves 116 (e.g., annular grooves) of the housing of the wellhead 12 (e.g., internal bore 24). In certain embodiments, the lockdown grooves 116 may include a single annular groove or a plurality of annular grooves. The tubing hanger 26 may then be secured to the housing of the wellhead 12 to prevent movement within the wellhead 12, thus enabling the tubing hanger 26 to support the entire load of the tubing spool. Therefore, to ensure that the tubing hanger 26 is properly inserted within the wellhead 12, the location of the lockdown grooves 116 is helpful during the installation of the tubing hanger 26. The lockdown grooves 116 may have a variety of profiles and cross-sectional geometries, including some with multiple annular teeth or annular tapered portions (e.g., conical portions). Thus, the location of the lockdown grooves 116 relative to the uppermost casing hanger 114 is used to preconfigure the tubing hanger before running in the tubing hanger 26 in the wellhead 12.

With this in mind, the lockdown elevation measurement tool 100 may include a contact tool 118 and a non-contact tool 120 configured to determine a location of the lockdown grooves 116 disposed on the housing of the wellhead 12 to further determine a distance (e.g., elevation) 56 between the uppermost casing hanger 114 and the lockdown grooves 116. As earlier mentioned, the lockdown elevation measurement tool 100 may be included with the combined tool 102, and the combined tool 102 includes one or more additional tools 101 to perform one or more additional operations within the wellhead 12 and/or the BOP 30. For example, the lockdown elevation measurement tool 100 may be integrated with the BOP tool 104 that may be deployed within the wellhead 12 to provide a BOP service (e.g., cleaning, testing, handling, etc.) for the BOP 24. The BOP service may include a pressure test and/or a seal test to ensure proper sealing of the BOP 30. In some embodiments, the BOP service may include a BOP actuator test to ensure proper actuation of the BOP 30. The lockdown elevation measurement tool 100 may also be integrated with the wear bushing tool 106 that may be configured for installation and retrieval of wear bushings temporarily inserted within the wellhead 12. The wear bushings may be positioned in the wellhead 12 within the casing hanger assembly 110 to prevent damage to the casing hanger assembly 110 and the wellhead 12 during drilling operations. Thus, the wear bushings may include one or more annular wear bushings configured to mount in the casing hangers 28. In some embodiments, the BOP tool 104, the wear bushing tool 106, and the lockdown elevation measurement tool 100 may be included in the combined tool 102. Additionally, the lockdown elevation measurement tool 100 may be integrated with the CHSART 108, and the CHSART 108 is deployed within the wellhead 12 to install a casing hanger 28 (e.g., uppermost casing hanger 114 and its associated lock and seal assembly 112A), which is configured to support and hang a casing string (e.g., casing component).

As illustrated, the combined tool 102 may be coupled to a component 124 (e.g., uppermost casing hanger 114, wear bushing, etc.), in which the combined tool 102 may perform an operation associated with the component 124. For example, the combined tool 102 may include both the CHSART 108 and the lockdown elevation measurement tool 100, such that the CHSART 108 installs the component 124 (e.g., uppermost casing hanger 114 and its associated lock and seal assembly 112A) in the wellhead 12 while the lockdown elevation measurement tool 100 obtains measurements at the installation site 34. By further example, the combined tool 102 may include both the wear bushing tool 106 and the lockdown elevation measurement tool 100, such that the wear bushing tool 106 installs or removes the component 124 (e.g., wear bushing) in the casing hanger assembly 110 while the lockdown elevation measurement tool 100 obtains measurements at the installation site 34.

During the deployment, the combined tool 102 is configured to land on the uppermost casing hanger 114 similar to a subsequent installation of the tubing hanger 26. Thus, while the combined tool 102 is deployed within the wellhead 12 and various operations are performed by the additional tools 101, the lockdown elevation measurement tool 100 concurrently determines a location of the lockdown grooves 116 within the wellhead 12 to further determine the distance 56 from the uppermost casing hanger 114 to the lockdown grooves 116. The distance 56 is an axial distance or elevation measured from a landing surface (e.g., axial end surface, tubing hanger landing surface) on the uppermost casing hanger 114 to the lockdown grooves 116. The lockdown elevation measurement tool 100 may be integrated with any tool suitable tool 126 configured to be deployed within the wellhead 12 and land on the uppermost casing hanger 114 similar to the tubing hanger 26 installation process. Therefore, incorporating the lockdown elevation measurement tool 100 with another tool deployed within the wellhead 12, may reduce the total cost and time of the formation process of the wellhead 12 (e.g., as compared to a separate measurement tool configured to measure the distance 56). In other words, rather than running multiple tools in separate trips, a single trip of the combined tool 102 reduces the time and costs associated with the various operations of the lockdown elevation measurement tool 100 and the one or more additional tools 101.

The power and control system 103 of the combined tool 102 may include a controller 128 and a power source 130 configured to control and power the operations of the lockdown elevation measurement tool 100, the additional tools 101, and/or the component 124. The power source 130 may include a local power source (e.g., one or more batteries or energy storage) and/or a power supply cable (e.g., electrical power cable to the surface). The controller 128 may include various components (e.g., a processor, a memory, and instructions stored on the memory and executable by the processor) to perform various measurement operations, actuation operations, and testing operations. In certain embodiments, the power and control system 103 shares the controller 128 and the power source 130 among the lockdown elevation measurement tool 100 and the additional tools 101. However, in some embodiments, each of the lockdown elevation measurement tool 100 and the additional tools 101 may alternatively or additionally include a dedicated controller and/or a dedicated power source. As earlier mentioned, the lockdown elevation measurement tool 100 includes the contact tool 118 and the non-contact tool 120 configured determine a location of the lockdown grooves 116 disposed on the wellhead 12, and thus the controller 128 may determine the distance 56 between the uppermost casing hanger 114 and the lockdown grooves 116 based on a total height between a landing shoulder of the combined tool 102 and the contact tool 118 and/or the non-contact tool 120 disposed on the lockdown elevation measurement tool 100. The contact tool 118 and the non-contact tool 120 may be controlled via the controller 128 and the power source 130.

The contact tool 118 may include a lead impression component configured to take an impression of the lockdown grooves 116. For example, the combined tool 102 may be deployed within the wellhead 12 in a downhole axial direction 50, and the landing shoulder of the combined tool 102 may land on the uppermost casing hanger 114. While the combined tool 102 is performing an operation associated with the component 124 (e.g., upper casing hanger, wear bushing, etc.) coupled to the combined tool 102, the controller 128 may control actuators of the lead impression component to apply pressure to the lead impression component. In certain embodiments, prior to obtaining an impression of the lockdown grooves 116, the contact tool 118 may operate one or more jetting nozzles of a fluid cleaning system, thereby applying a fluid jet on the lockdown grooves 116 to clean the lockdown grooves 116 of any debris. In response to the applied pressure, the lead impression component may then outwardly extend in the radial direction 52 to press against the lockdown grooves 116 and the adjacent housing of the wellhead 12. It should be understood that the contact tool 118 may include any suitable mechanical component configured to take an impression of the lockdown grooves 116. In certain embodiments, the lead impression component may include a block or plate (e.g., impression plates) including a soft material that deforms when forced against the lockdown grooves 116, thereby obtaining an imprint of the lockdown grooves 116. For example, the soft material may include a lead material, such as a lead block (e.g., lead impression plate). After a completion of the operation of the combined tool 102, an operator may be determine the distance 56 between the uppermost casing hanger 114 and the lockdown grooves 116 by measuring a distance between the landing shoulder of the combined tool 102 and a location the mechanical component on the combined tool 102.

The non-contact tool 120 of the lockdown elevation measurement tool 100 may include multiple sensor devices configured to locate the lockdown grooves 116, and the controller 128 may determine the distance 56 between uppermost casing hanger 114 and the lockdown grooves 116. While the combined tool 102 is deployed within the wellhead 12, the controller 128 may be configured to control the sensor devices of the lockdown elevation measurement tool 100 to transmit and receive signals, take pictures, or any suitable method to determine the location of the lockdown grooves 116. The controller 128 may then receive measurement data from the sensor devices to process and determine the distance 56. After determining the distance 56, a distance between the locking mechanism of the tubing hanger 26 and the landing shoulder of the tubing hanger 26 may be adjusted based on the distance 56 to ensure that the tubing hanger 26 properly locks with the lockdown grooves 116. In certain embodiments, the non-contact tool 120 may include optical measurement tools, inductive and magnetic measurement tools, wireless signal tools, imaging tools or cameras, or any combination thereof. For example, the optical measurement tools may include light emitting and receiving tools, such as laser measurement tools and/or light detecting and ranging (LiDAR) tools. By further example, the wireless signal tools may include acoustic measurement tools, such as ultrasonic measurement tools configured to transmit, receive, and process ultrasonic signals. By further example, the non-contact tool 120 may obtain real-time measurements via dissimilar materials, magnetic fields, acoustic waves, laser measurement, or any combination thereof.

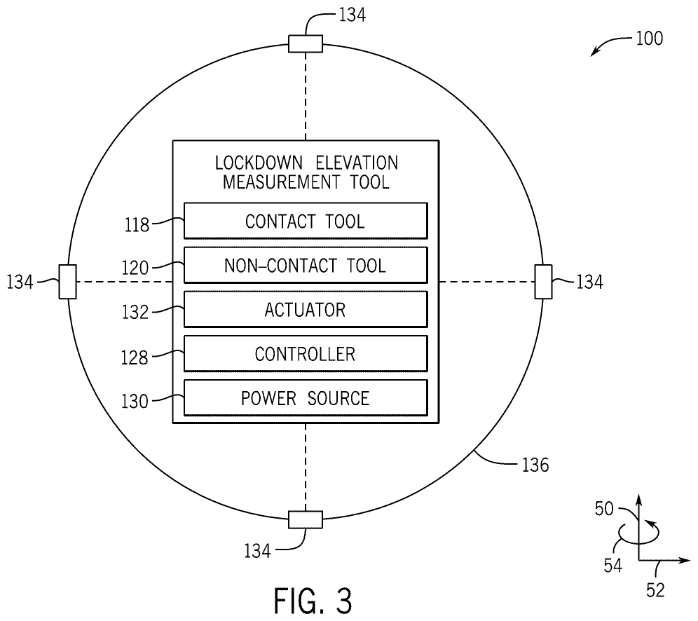

FIG. 3 is a schematic top view of an embodiment of the lockdown elevation measurement tool 100 of FIG. 2. As mentioned above, the lockdown elevation measurement tool 100 may include the controller 128 and the power source 130 to control, operate, and power the contact tool 118 and the non-contact tool 120. The lockdown elevation measurement tool 100 may include a plurality of measurement devices 134 (e.g., mechanical component, sensor devices, etc.) of the contact tool 118 and the non-contact tool 120. In certain embodiments, each of the measurement devices 134 includes one or more types of mechanical components of the contact tool 118 and/or one or more sensor devices of the non-contact tool 120. In some embodiments, each of the measurement devices 134 is the same at the different locations around the combined tool 102. In some embodiments, each of the measurement devices 134 is different at the different locations around the combined tool 102. Additionally, the lockdown elevation measurement tool 100 may include 1, 2, 3, 4, 5, 6, 7, 8, 9, 10, or more measurement devices 134. Thus, a variety of configurations of the measurement devices 134 may be used with the lockdown elevation measurement tool 100 to obtain measurements at the installation site 34, thereby providing different and/or redundant measurements of the distance 56.

The contact tool 118 may include a mechanical component (e.g., a lead impression component) that may take an impression of the lockdown grooves 116. For example, the lockdown elevation measurement tool 100 may include an actuator 132 configured to apply pressure to the mechanical component. The actuator 132 may include an electric actuator, a fluid actuator (e.g., a hydraulic or pneumatic actuator), or a combination thereof, configured to drive movement of the mechanical component in the radial direction 52. The mechanical component may then extend outwards in the radial direction 52 and press firmly onto the lockdown grooves 116, thus enabling the impression of the lockdown grooves 116 onto the mechanical component. The distance 56 from the landing shoulder of the combined tool 102 and the lockdown grooves'116 impression on the mechanical component of the lockdown elevation measurement tool 100 may be used to adjust a location of the locking mechanism (e.g., lock ring, metal ring, c-shaped ring, etc.) disposed on the tubing hanger 26 with respect to the landing shoulder of the tubing hanger 26.

In some embodiments, the lockdown elevation measurement tool 100 may include the non-contact tool 120 that may include a sensor device configured to collect measurement data indicative of a location of the lockdown grooves 116 within the housing of the wellhead 12. As discussed above, the sensor devices of the non-contact tool 120 may include optical measurement tools, inductive and magnetic measurement tools, wireless signal tools, imaging tools or cameras, etc.). For example, the sensor devices may include a camera, a LiDAR device, an acoustic device, or any suitable device configured to collect the measurement data indicative of the location of the lockdown grooves 116 without contacting the wellhead 12 (e.g., non-contact measurement techniques). For example, the sensor devices may include a camera configured to collect a photograph of the lockdown grooves 116 upon detecting that the lockdown grooves 116 is in view (e.g., radially ahead) of the camera. That is, the controller 128 may control the camera to collect a photograph of the lockdown grooves 116 and determine the distance 56 from the landing shoulder of the combined tool 102 having the lockdown elevation measurement tool 100. As another example, the sensor devices may include a LiDAR device configured to emit laser lights to determine the location and distance 56 of the lockdown grooves 116 within the wellhead 12.

Further, the sensor devices may include an acoustic device that includes at least one transducer configured to emit excitation signals and receive excitation signals to determine the location of the lockdown grooves 116. The at least one transducer may include a transmitter and a receiver and/or a transceiver configured to emit excitation signals onto an interior housing of the wellhead 12 and receive the excitation signals that interacted with the wellhead 12. In some embodiments, the transmitter and/or transceiver may emit the excitation signals at particular angles of incidence onto the wellhead 12 and at varying beam-forming modes.

As illustrated, the measurement devices 134 (e.g., mechanical components of contact tool 118 and sensor devices of non-contact tool 120) may be azimuthally disposed along an exterior surface of an outer wall 136 (e.g., outer annular wall or collar) of the lockdown elevation measurement tool 100. The measurement devices 134 may include the sensor devices of the non-contact tool 120 and the mechanical components of the contact tool 118. In some embodiments, the lockdown elevation measurement tool 100 may solely include measurement devices 134 configured as one of the sensor devices (e.g., camera, LiDAR device, acoustic device, etc.) of the non-contact tool 120 described above. In other embodiments, the measurement devices 134 may include different types of the sensor devices and may be arranged in an alternating order circumferentially around the outer wall 136 of the lockdown elevation measurement tool 100. In some embodiments, the measurement devices 134 may include both the mechanical components of the contact tool 118 and the sensor devices of the non-contact tool 120 arranged in alternating order circumferentially around the outer wall 136 of the lockdown elevation measurement tool 100. Although only four measurement devices 134 are illustrated in FIG. 3, it should be understood that the lockdown elevation measurement tool 100 may include any number and circumferential spacings of the measurement devices 134 configured to determine the location and distance 56 of the lockdown grooves 116.

In some embodiments, the lockdown elevation measurement tool 100 may include an array of measurement devices 134 arranged over an axial distance along the axial direction 50 (e.g., an axial measurement array). For example, the axial measurement array may include a plurality of sensor devices of the non-contact tool 120. That is, the lockdown elevation measurement tool 100 may include sensor devices aligned in a longitudinal direction along the outer wall 136 of the lockdown elevation measurement tool 100. The controller 128 may then control the array of sensor devices to obtain measurements (e.g., take photographs, emit laser lights, and/or emit excitation signals) in response to determining that the combined tool 102 having the lockdown elevation measurement tool 100 is landed on the uppermost casing hanger 114.

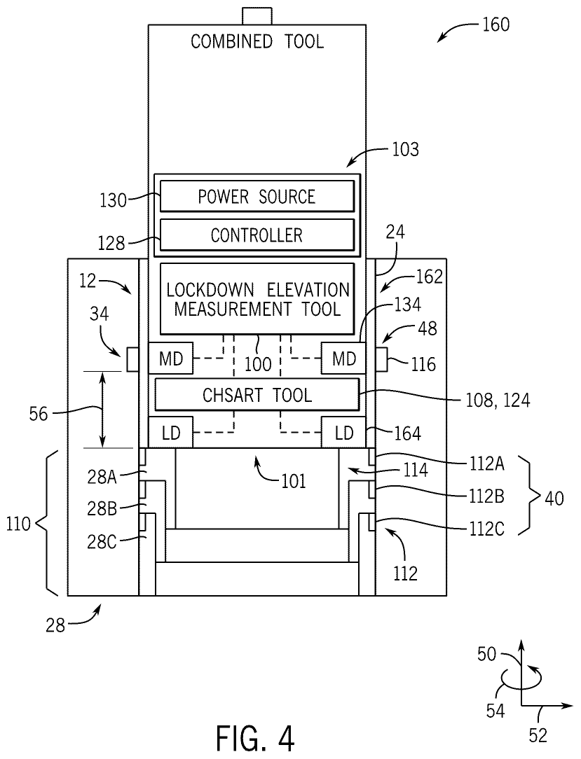

FIG. 4 is a schematic side view of an embodiment of one of the tools 32 of FIG. 1, further illustrating a combined tool 160 (e.g., tool string) including the lockdown elevation measurement tool 100 integrated with the CHSART 108 and deployed in the wellhead 12. As illustrated, the combined tool 160 is positioned within a center of the wellhead 12 and configured to install the uppermost casing hanger 114, while measuring a location of the lockdown grooves 116 disposed on an interior housing 162 of the wellhead 12. As earlier mentioned, the combined tool 160 may include the controller 128 configured to control and operate both the CHSART 108 and the lockdown elevation measurement tool 100. The combined tool 160 may also include the power source 130 configured to power the CHSART 108 and the lockdown elevation measurement tool 100.

For example, during the deployment process of the combined tool 160 within the wellhead 12, the combined tool 160 may be lowered into the wellhead 12 in the downhole axial direction 50, and the CHSART 108 of the combined tool 160 may carry the uppermost casing hanger 114 (e.g., component 124). After the CHSART 108 disposes the uppermost casing hanger 114 on top of a prior installed casing hanger 28 (e.g., 28B) and the lock and seal assembly 112A of the uppermost casing hanger 114 properly locks and seals with the interior housing 162 of the wellhead 12, the combined tool 160 may be configured in a landed position. That is, a landing shoulder of the combined tool 160 may be positioned on the uppermost casing hanger 114 (e.g., resting on an uppermost landing surface of the uppermost casing hanger 114).

In some embodiments, the controller 128 may receive sensor data from landing devices 164 (e.g., landing detection devices or landing detectors) of the combined tool 160 indicative of the combined tool 160 is in the landed position. The landing devices 164 may include a mechanical component, a sensor component, or both. For example, in the embodiment that the landing devices 164 includes sensor components, the sensor components may be configured to collect landing data of the combined tool 160 and transmit the data to the controller 128. In certain embodiments, the sensor components include optical measurement tools, inductive and magnetic measurement tools, wireless signal tools, imaging tools or cameras, or any combination thereof. For example, the optical measurement tools may include light emitting and receiving tools, such as laser measurement tools and/or light detecting and ranging (LiDAR) tools. By further example, the wireless signal tools may include acoustic measurement tools, such as ultrasonic measurement tools configured to transmit, receive, and process ultrasonic signals. The sensor components may be transceivers or each include a transmitter and a receiver. The controller 128 may send control signals to the sensor components to collect landing data, where the transmitters are configured to transmit excitation signals and the respective receivers are configured to receive the excitation signals. It should be understood that the sensor components may be configured as any suitable type of sensor configured to collect data indicative that the combined tool 160 is in the landed position. The controller 128 may then analyze the landing data to determine that the combined tool 160 is properly situated on the uppermost casing hanger 114 and that the combined tool 160 may begin operations including identifying the location of the lockdown grooves 116 disposed on the interior housing 162 of the wellhead 12.

In some embodiments, the landing devices 164 may include mechanical components configured to transmit a signal to the controller 128 indicative that the landing shoulder of the combined tool 160 is properly situated on the uppermost casing hanger 114. For example, the uppermost casing hanger 114 may include an attachment and release mechanism configured to couple to the landing shoulder of the combined tool 160. The attachment and release mechanism of the uppermost casing hanger 114 may include a pin configured to couple to the mechanical component of the landing devices 164. Thus, after the mechanical component of the landing devices 164 couples with the pin of the attachment and release mechanism of the uppermost casing hanger 114, the landing devices 164 may transmit a signal to the controller 128. The controller 128 may then receive the signal from the landing devices 164 and determine that the combined tool 160 is configured in the landing position. In certain embodiments, the mechanical components of the landing devices 164 may include a mechanical push-button (e.g., spring-loaded button) that depresses upon contact between the combined tool 160 and the uppermost casing hanger 114. In certain embodiments, the mechanical components of the landing devices 164 may include any suitable electro-mechanical position sensors.

After the controller 128 determines that the combined tool 160 is ready to begin measuring the location of the lockdown grooves 116, the controller 128 may control the lockdown elevation measuring tool 100 to actuate the measurement devices 134 azimuthally disposed on the outer wall 136 of the lockdown elevation measurement tool 100. As described above with respect to FIG. 3, the measurement devices 134 may include a contact tool 118, a non-contact tool 120, or both. For example, the controller 128 may send control signals to the measurement devices 134 of the contact tool 118 to actuate lead impression components to extend radially outward in the radial direction 52. The lead impression components may take impressions of the lockdown grooves 116, and an operator may determine the distance 56 between the uppermost casing hanger 114 and the lockdown grooves 116 based on a distance between the landing shoulder of the combined tool 160 and the location of the impressions of the lockdown grooves 116 on the lead impression component. It should be understood that the contact tool 118 may include any suitable component configured to take impressions of the lockdown grooves 116.

In some embodiments, the measurement devices 134 may include a non-contact tool 120, where the non-contact tool 120 may determine the location of the lockdown grooves 116 without contacting the housing of the wellhead 12 (e.g., non-contact measurement techniques). For example, the non-contact tool 120 may include at least one transducer (e.g., at least one transmitter and/or at least one receiver) azimuthally disposed on the outer wall 136 of the combined tool 160. The lockdown elevation measurement tool 100 may begin to collect measurement data via the controller 128 controlling the at least one transducer to transmit wireless signals that may interact with the interior housing 162 of the wellhead 12 and to receive the wireless signals. The controller 128 may then analyze the measurement data and determine the location of the lockdown grooves 116 and the distance 56 between the uppermost casing hanger 114 and the lockdown grooves 116. The controller 128 may then notify an operator of the distance 56, and the operator may adjust the elevation between the locking mechanism of the tubing hanger 26 and the landing shoulder of the tubing hanger 26 to accommodate the distance 56.

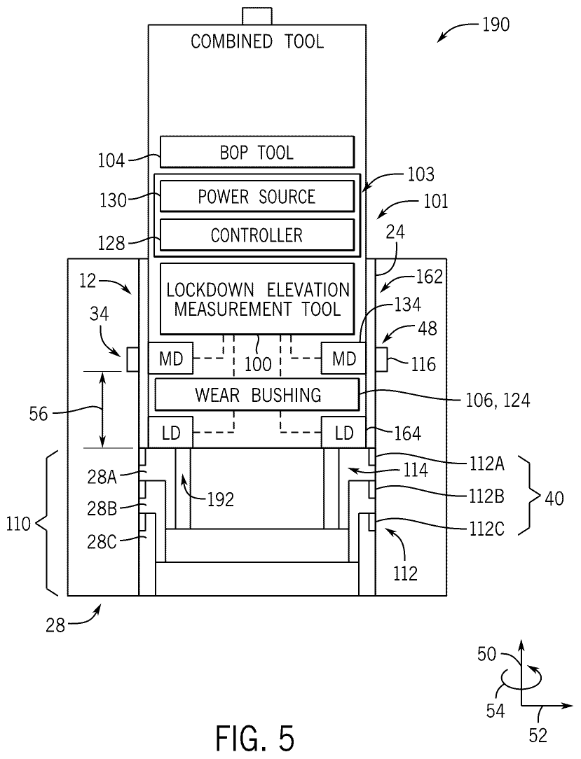

FIG. 5 is a schematic side view of an embodiment of one of the tools 32 of FIG. 1, further illustrating a combined tool 190 (e.g., tool string) including the lockdown elevation measurement tool 100 integrated with the wear bushing tool 106 and the BOP tool 104 and deployed in the wellhead 12. As illustrated, the combined tool 190 is positioned within a center of the wellhead 12 and configured to install wear bushings 192 (e.g., annular wear bushings) and perform operations on the BOP 30, while measuring a location of the lockdown grooves 116 disposed on the interior housing 162 of the wellhead 12. As earlier mentioned, the combined tool 190 may include the controller 128 configured to control and operate the wear bushing tool 106, the BOP tool 104, and the lockdown elevation measurement tool 100. The combined tool 190 may also include the power source 130 configured to power the wear bushing tool 106, the BOP tool 104, and the lockdown elevation measurement tool 100.

For example, during the deployment process of the combined tool 190 within the wellhead 12, the combined tool 190 may be lowered into the wellhead 12 in the downhole axial direction 50, and the wear bushing tool 106 may carry the wear bushings 192 (e.g., component 124). The combined tool 190 may include a landing shoulder configured to land on a landing surface of the uppermost casing hanger 114. As earlier described, the combined tool 190 may include landing devices 164 that may include a mechanical component, a sensor component, or both, configured to send signals or collect data to the controller 128 indicative that the combined tool 190 is in the landed position. The controller 128 may then transmit signals to the wear bushing tool 106 to install the wear bushings 192 within the casing hanger assembly 110 to protect the casing hanger assembly 110 (e.g., casing hangers 28) and the wellhead 12 from future downhole operations.

The controller 128 may also transmit signals to the BOP tool 104 to conduct a BOP service to the BOP 30. For example, the BOP tool 104 may be configured to collect testing data of the BOP 30 to ensure that the BOP 30 is operating properly and efficiently. In certain embodiments, the BOP service may include a pressure test and/or a seal test to ensure proper sealing of the BOP 30. In some embodiments, the BOP service may include a BOP actuator test to ensure proper actuation of the BOP 30. The controller 128 may then receive the testing data and determine whether the BOP 30 passes or fails various tests. The controller 128 may transmit test results to a surface computer and/or control for further analysis and decision making. For example, the controller 128 may send the test results along with suggested remedial actions if one or more of the tests fail.

During the installation of the wear bushings 192 via the wear bushing tool 106 and the operating service to the BOP 30, the controller 128 may control the lockdown elevation measurement tool 100 to, concurrently, begin collecting measurements and location data of the lockdown grooves 116. For example, the lockdown elevation measurement tool 100 may control the measurement device 134 to extend an impression component of the measurement device 134 to collect the measurement data via the contact tool 118. By further example, the lockdown elevation measurement tool 100 may control the measurement device 134 to actuate sensor devices of the measurement device 134 to collect the measurement data via the non-contact tool 120. In certain embodiments, the controller 128 may analyze the measurement data in real time and determine if the non-contact tool 120 is accurately measuring the location of the lockdown grooves 116 disposed on the interior housing 162 of the wellhead 12. In some embodiments, the controller 128 may analyze the measurement data from a plurality of the measurement devices 134, wherein the measurement devices 134 may include the same or different sensor devices, the same or different positions, or any combination thereof. For example, the controller 128 may evaluate optical measurements, wireless measurements, and/or inductive and magnetic measurements for increased measurement accuracy. If the controller 128 determines that the various measurements each indicate the same distance 56 within a threshold range, then the controller 128 may determine that the distance 56 is an accurate measurement. Otherwise, if the controller 128 determines that the various measurements are inaccurate based on the analysis (e.g., various measurements not within the threshold range), then the controller 128 may perform various adjustments to the non-contact tool 120 and its measurement devices 134 to help improve the measurement accuracy. In other words, the controller 128 may help to resolve or correct any measurement issues while the combined tool 190 is deployed downhole, thereby enabling additional measurements (if needed) to avoid additional trips. In this manner, the combined tool 190 improves the efficiency of completing various tasks downhole in a single trip of the combined tool 190 for preparing a wellhead 12 (e.g., as compared to a separate measurement tool including only a contact tool).

Although embodiments described herein describe the lockdown elevation measurement tool 100 combined with specific additional tools 101, it should be understood that the lockdown elevation measurement tool 100 may be installed in any additional tool 101 configured to deploy within the wellhead 12 during the lower completion process and configured to land on the uppermost casing hanger 114. For example, the additional tools 101 may include other (e.g., suitable) tools 126, such as seal installation and/or removal tools, seal testing tools (e.g., pressure testing tools) for the casing hangers 28, landing verification tools for the casing hangers (e.g., sensors that verify proper landing of the casing hangers), surface damage inspection tools for inspecting the interior surface of the wellhead 12 and/or the casing hangers 28, or any combination thereof. In some embodiments, the additional tools 101 may not be needed along with the lockdown elevation measurement tool 100 depending on the current state of the wellhead 12. Accordingly, the lockdown elevation measurement tool 100 may be used separate from the additional tools 101.

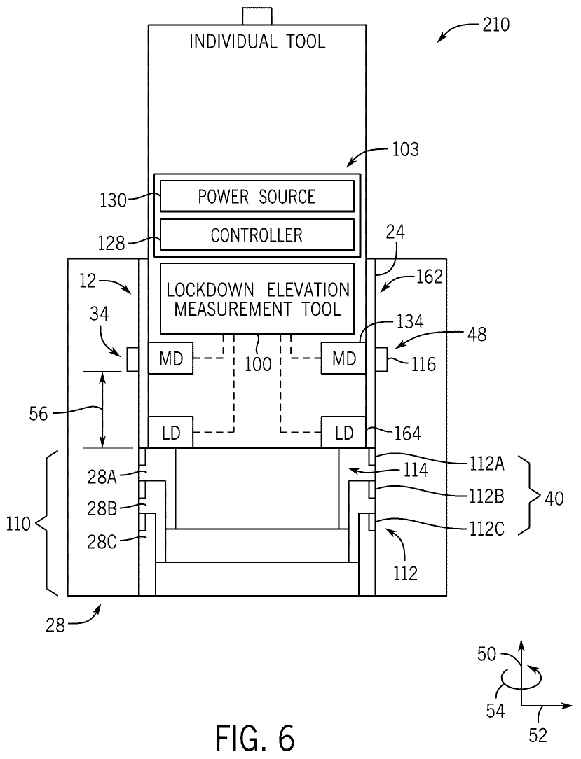

FIG. 6 is a schematic side view of an embodiment of one of the tools 32 of FIG. 1, further illustrating an individual tool 210 including the lockdown elevation measurement tool 100. As earlier mentioned, the lockdown elevation measurement tool 100 may be deployed within the wellhead 12 in a separate measurement (e.g., as compared to combining the lockdown elevation measurement tool 100 with one or more additional tool 101). That is, the lockdown elevation measurement tool 100 may separately collect measurement data of the lockdown grooves 116 without any other tool operations. However, in this embodiment, the lockdown elevation measurement tool 100 may only include a non-contact tool 120 or a combination of both the contact tool 118 and the non-contact tool 120. For example, the measurement devices 134 may include one or more sensor devices configured to collect measurement data of the location of the lockdown grooves 116 without contacting the wellhead 12 (e.g., non-contact measurement techniques). In embodiments with both the contact tool 118 and the non-contact tool 120, the measurement devices 134 further include the mechanical component of the contact tool 118 as described in detail above.

For example, during the deployment process of the individual tool 210 within the wellhead 12, the landing sensor devices 164 may transmit signals to the controller 128 to determine that the individual tool 210 has landed on the uppermost casing hanger 114. In response to determining that the uppermost casing hanger 114 is in the landed position, the controller 128 may transmit signals to the measurement devices 134 of the non-contact tool 120 to collect measurement data. For example, the measurement devices 134 of the non-contact tool 120 may include at least one transducer configured to transmit excitation signals to interact with the wellhead 12 and collect the excitation signals. In some embodiments, the non-contact tool 120 may operate during the deployment (e.g., lowering) of the individual tool 210. That is, the non-contact tool 120 may collect measurement data as the individual tool 210 is lowered onto the uppermost casing hanger 114.

In certain embodiments, all aspects of FIG. 1-6 are intended for use in any combination with one another. Thus, the foregoing discussion of FIG. 1-6 presents some possible options for the lockdown elevation measurement tool 100 having the non-contact tool 120 with or without the contact tool 118, and also including or excluding additional tools 101. The following discussion generally presents embodiments of lockdown elevation measurement tool 100 without reference to the foregoing figures.

Embodiments of the present disclosure may be directed toward a method for taking measurements of an upper casing hanger to lock down grooves in a high-pressure housing. More specifically, embodiments of the present disclosure may be directed toward a method for taking measurements of an upper casing hanger to lockdown grooves after completion of drilling activities and prior to installing lower completion, prior to drilling activities for lower and upper completion, and after drilling activities prior to or after the installation of lower completion.

In one or more embodiments, devices used for taking the measurement may be in the form of physical mechanical measurement (actuated lead plates) or sensory devices for real time measurement (using dissimilar materials, magnetic fields, acoustic waves, laser measurement, etc.). In an embodiment with the uppermost casing hanger installed, the wear bushings in place, and drilling for the upper and lower completions completed, one of option 1 (dedicated wear bushing retrieval tool coupled with lead impression plates and jetting nozzle), option 2 (wear bushing and running retrieval tool coupled with lead impression plates and jetting nozzle), or option 3 (combined wear busing retrieval and BOP test tool coupled with lead impression plates and jetting nozzle) may be the tool for taking the measurement. In one or more embodiments, each of the options 1, 2, and 3 may include one or more lead impression slugs on the underside of the tool to confirm land off tool on the wear bushing. In one or more embodiments, each of the options 1, 2, and 3 may include one or more lead impression plates to confirm elevation of the lockdown grooves.

In one or more embodiments, the sequence for taking measurement using the option 1, the option 2, or the option 3 may include prepping tool at surface, jetting area to remove debris prior to landing off, landing off tool on wear bushing and set down weight to latch tool to wear bushing while maintaining drill string weight, applying pressure down drill string and extending and holding lead impression plates, venting pressure and allowing plates to retract, recovering tool and wear bushing, examining for indentation of land off slugs to confirm successful land off, installing tool in tubing hanger stand, calibrating tubing hanger with the tool, inserting the tubing hanger into the calibrated stand, aligning indicator in the stand with the shoulder on the tubing hanger, and adjusting the tubing hanger land off shoulder to the measured datum.

In an embodiment with the uppermost casing hanger installed and the seal assembly set, option 4 (CHSART coupled with lead impression plates) may be the tool for taking the measurement. In one or more embodiments, option 4 may include one or more lead impression slugs on the underside of the tool to confirm land off position on to the casing hanger. In one or more embodiments, option 4 may include one or more lead impression plates to confirm elevation of the lockdown groove. The usage of option 4 has the longest duration from taking the measurement to installing the upper completion.

In one or more embodiments, the sequence for taking measurement using the option 4 may include prepping tool at surface, jetting area to remove debris prior to landing off, landing off and setting down uppermost casing hanger softly on lower casing hanger or spacer, completing cementing operation, setting the seal assembly with normal CHSART function, applying pressure to extend and hold lead impression plates, venting pressure and allow plates to retract, releasing and recovering CHSART, examining indentation of land off slugs to confirm successful land off position, installing tool in tubing hanger stand, calibrating the tubing hanger stand with the tool, inserting the tubing hanger into the calibrated stand, aligning indicator in the stand with the shoulder of the tubing hanger, and adjusting the tubing hanger land off shoulder to the measured datum.

In an embodiment with the uppermost casing hanger installed, wear bushing in place, and drilling for the upper and lower completion completed, one of option 5 (dedicated wear bushing retrieval tool coupled with sensory devices and jetting nozzle), option 6 (wear bushing and running retrieval tool coupled with sensory devices and jetting nozzle), and option 7 (combined wear bushing retrieval and BOP test tool coupled with sensory devices and jetting nozzle) may be the tool for taking the measurement. In one or more embodiments, each of options 5, 6, and 7 may include: an intelligent sub at the top of the landing string, which controls the electronic package that wirelessly receives data from the tools; a data acquisition box providing dimensional and component information relayed from the tool downhole for receiving information wirelessly from the intelligent sub; and one or more sensory devices on the underside of the tool to confirm land off tool on the wear bushing and the elevation of the lockdown groove.

In one or more embodiments, the sequence for taking measurement using the option 5, the option 6, or the option 7 may include prepping tool at surface, jetting area to remove debris prior to landing off, landing off tool on wear bushing and setting down weight to latch tool to wear bushing while maintaining drill string weight, activating the tool from the surface, receiving information in real time, and, while recovering the tool and wear bushing, inserting tubing hanger into calibration stand and adjusting tubing hanger land off shoulder based on the data received.

In an embodiment with the uppermost casing hanger installed and the seal assembly set, option 8 (CHSART coupled with sensory devices) may be the tool for taking the measurement. In one or more examples, option 8 may include an intelligent sub run at the top of the landing string, which controls the electronic package that wirelessly receives data from the CHSART, and a data acquisition box for receiving information wirelessly from the intelligent sub.

In one or more embodiments, the sequence for taking measurement using the option 8 may include prepping tool at surface, landing off and setting down uppermost casing hanger softly on lower casing hanger or spacer, completing cementing operation, operating CHSART as normal to set the seal assembly, activating the tool from the surface, receiving information in real time, releasing the CHSART, and, while recovering the CHSART, inserting tubing hanger into calibration stand and adjusting tubing hanger land off shoulder based on the received data.

In an embodiment with lower completion installed, option 9 (dedicated measurement tool coupled with sensory devices and jetting nozzle) may be the tool for taking the measurement. In one or more embodiments, option 9 may include an intelligent sub run at the top of the landing string, which controls the electronic package that wirelessly receives data from the tool; a data acquisition box providing dimensional and component information relayed from the tool downhole for receiving information wirelessly from the intelligent sub; and one or more sensory devices on the underside of the tool to confirm land off tool on the casing hanger to confirm elevation of the lockdown groove. Option 9 represents the most accurate option, and cost savings may be generated as the tubing hanger may be adjusted and set whilst the tool is being recovered.

In one or more embodiments, the sequence for taking measurement using the option 9 may include prepping tool at surface, jetting area to remove debris prior to landing off, landing off tool on uppermost casing hanger while maintaining drill string weight, activating the tool from the surface, receiving information in real time, and, while recovering the tool, inserting tubing hanger into calibration stand and adjusting tubing hanger land off shoulder based on the data received.

Advantageously, the options 1-9 for taking measurement in parallel with other activities such as the retrieving of the wear bushing, or after setting the casing hanger seal assembly reduces the duration that drilling vessel is on station attached to the well, reduces operational expenses by negating the need for a dedicated trip for standalone LIT activities, and by introducing schedule adaptability with tubing hanger adjustment and setting activity carried out by a local service center or on a drilling vessel (as elevation of the tubing hanger lockdown mechanism to landing shoulder can be set concurrently).

Technical effects of the disclosure include decreasing the total time and costs of the lower completion process. Combining the lockdown elevation measurement tool with different tools used during the lower completion process may substantially improve the lower completion process with respect to time and costs. Additionally, including a non-contact tool in the lockdown elevation measurement tool to collect measurement data indicative of a location of the lockdown grooves for a tubing hanger of the wellhead may result in more accurate distance (e.g., elevation) measurements between the uppermost casing hanger and the lockdown grooves disposed on the wellhead. Accordingly, the tubing hanger may be adjusted to accommodate the distance measured between the uppermost casing hanger and the lockdown grooves, ensuring that the tubing hanger may properly lock with the lockdown grooves and the wellhead. Thus, the production tubing supported by the tubing hanger may extract hydrocarbons safely and securely. Therefore, the lockdown elevation measurement tool may reduce time and costs spent to prepare the tubing hanger for deployment, while improving the safety of the wellhead and the upper completion process.

The subject matter described in detail above may be defined by one or more clauses, as set forth below.

A system includes a downhole tool configured to run into a wellhead of a resource extraction system. The downhole tool includes a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation. The downhole tool further includes one or more additional tools configured to perform one or more additional operations in the wellhead, a blowout preventer (BOP) coupled to the wellhead, or a combination thereof.

The system of the preceding clause, wherein the lockdown elevation measurement tool includes a contact tool, a non-contact tool, or a combination thereof, configured to obtain the measurements indicative of the location.

The system of any preceding clause, including the contact tool having one or more first measurement devices and the non-contact tool having one or more second measurement devices, wherein the first and second measurement devices are arranged in the same or different positions along the downhole tool.

The system of any preceding clause, wherein the first and second measurement devices are arranged in a plurality of circumferential positions about a central axis of the downhole tool, a plurality of axial positions over an axial distance along the central axis, or any combination thereof.

The system of any preceding clause, wherein the one or more additional tools include a wear bushing tool, a casing hanger tool, a blowout preventer (BOP) tool, or any combination thereof.

The system of any preceding clause, wherein the lockdown elevation measurement tool includes a non-contact tool having one or more measurement devices configured to obtain non-contact measurements indicative of the location to determine a distance from the uppermost casing hanger to the one or more lockdown grooves.

The system of any preceding clause, wherein the one or more measurement devices include an optical measurement tool, a magnetic measurement tool, a wireless signal tool, an imaging tool or camera, or any combination thereof.

The system of any preceding clause, wherein the one or more measurement devices include an optical measurement tool having a laser measurement tool or a light detecting and ranging (LiDAR) tool.

The system of any preceding clause, wherein the one or more measurement devices include a wireless signal tool having an acoustic measurement tool or an ultrasonic measurement tool.

The system of any preceding clause, wherein the one or more measurement devices are arranged in a plurality of circumferential positions about a central axis of the downhole tool, a plurality of axial positions over an axial distance along the central axis, or a combination thereof.

The system of any preceding clause, including a controller having a processor, a memory, and instructions stored on the memory and executable by the processor to receive measurement data of the one or more measurements indicative of the location of the one or more lockdown grooves, and determine the distance based on the measurement data.

The system of any preceding clause, wherein the lockdown elevation measurement tool includes one or more landing detectors configured to detect a landing of the downhole tool on the uppermost casing hanger in the wellhead, wherein the controller is configured to initiate the one or more measurements in response to detection of the landing.

A method includes running a downhole tool into a wellhead of a resource extraction system. The method further includes operating a lockdown elevation measurement tool of the downhole tool to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation. The method further includes operating one or more additional tools of the downhole tool to perform one or more additional operations in the wellhead, a blowout preventer (BOP) coupled to the wellhead, or a combination thereof.

The method of the preceding clause, wherein operating the lockdown elevation measurement tool to collect one or more measurements includes obtaining non-contact measurements indicative of the location to determine a distance from the uppermost casing hanger to the one or more lockdown grooves.

The method of any preceding clause, wherein obtaining the obtaining non-contact measurements includes obtaining optical measurements, magnetic measurements, wireless measurements, images, or any combination thereof.

The method of any preceding clause, wherein operating the lockdown elevation measurement tool to collect one or more measurements includes obtaining contact measurements indicative of the location.

The method of any preceding clause, wherein operating the one or more additional tools includes operating a wear bushing tool, a casing hanger tool, a blowout preventer (BOP) tool, or any combination thereof, of the downhole tool.

A system includes a downhole tool configured to run into a wellhead of a resource extraction system. The downhole tool includes a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation, wherein the lockdown elevation measurement tool includes a non-contact tool having one or more measurement devices configured to obtain the one or more measurements indicative of the location to determine a distance from the uppermost casing hanger to the one or more lockdown grooves. The downhole tool further includes a controller having a processor, a memory, and instructions stored on the memory and executable by the processor to receive measurement data of the one or more measurements indicative of the location of the one or more lockdown grooves, and determine the distance based on the measurement data.

The system of the preceding clause, wherein the one or more measurement devices include an optical measurement tool, a magnetic measurement tool, a wireless signal tool, an imaging tool or camera, or any combination thereof.

The system of any preceding clause, wherein the lockdown elevation measurement tool includes one or more landing detectors configured to detect a landing of the downhole tool on the uppermost casing hanger in the wellhead, wherein the controller is configured to initiate the one or more measurements in response to detection of the landing.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). However, for any claims containing elements designated in any other manner, it is intended that such elements are not to be interpreted under 35 U.S.C. § 112(f).

1. A system, comprising:
a downhole tool configured to run into a wellhead of a resource extraction system, wherein the downhole tool comprises:
a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation; and
one or more additional tools configured to perform one or more additional operations in the wellhead, a blowout preventer (BOP) coupled to the wellhead, or a combination thereof.

2. The system of claim 1, wherein the lockdown elevation measurement tool comprises a contact tool, a non-contact tool, or a combination thereof, configured to obtain the measurements indicative of the location.

3. The system of claim 2, wherein the contact tool includes one or more first measurement devices and the non-contact tool includes one or more second measurement devices, where the first and second measurement devices are arranged in the same or different positions along the downhole tool.

4. The system of claim 3, wherein the first and second measurement devices are arranged in a plurality of circumferential positions about a central axis of the downhole tool, a plurality of axial positions over an axial distance along the central axis, or any combination thereof.

5. The system of claim 2, wherein the one or more additional tools comprises a wear bushing tool, a casing hanger tool, a blowout preventer (BOP) tool, or any combination thereof.

6. The system of claim 1, wherein the lockdown elevation measurement tool comprises a non-contact tool having one or more measurement devices configured to obtain non-contact measurements indicative of the location to determine a distance from the uppermost casing hanger to the one or more lockdown grooves.

7. The system of claim 6, wherein the one or more measurement devices comprises an optical measurement tool, a magnetic measurement tool, a wireless signal tool, an imaging tool or camera, or any combination thereof.

8. The system of claim 6, wherein the one or more measurement devices comprises an optical measurement tool having a laser measurement tool or a light detecting and ranging (LiDAR) tool.

9. The system of claim 6, wherein the one or more measurement devices comprises a wireless signal tool having an acoustic measurement tool or an ultrasonic measurement tool.

10. The system of claim 6, wherein the one or more measurement devices are arranged in a plurality of circumferential positions about a central axis of the downhole tool, a plurality of axial positions over an axial distance along the central axis, or a combination thereof.

11. The system of claim 6, comprising a controller having a processor, a memory, and instructions stored on the memory and executable by the processor to:
receive measurement data of the one or more measurements indicative of the location of the one or more lockdown grooves; and
determine the distance based on the measurement data.

12. The system of claim 11, wherein the lockdown elevation measurement tool comprises one or more landing detectors configured to detect a landing of the downhole tool on the uppermost casing hanger in the wellhead, wherein the controller is configured to initiate the one or more measurements in response to detection of the landing.

13. A method, comprising:
running a downhole tool into a wellhead of a resource extraction system;
operating a lockdown elevation measurement tool of the downhole tool to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation; and
operating one or more additional tools of the downhole tool to perform one or more additional operations in the wellhead, a blowout preventer (BOP) coupled to the wellhead, or a combination thereof.

14. The method of claim 13, wherein operating the lockdown elevation measurement tool to collect one or more measurements comprises obtaining non-contact measurements indicative of the location to determine a distance from the uppermost casing hanger to the one or more lockdown grooves.

15. The method of claim 14, wherein obtaining the non-contact measurements comprises obtaining optical measurements, magnetic measurements, wireless measurements, images, or any combination thereof.

16. The method of claim 14, wherein operating the lockdown elevation measurement tool to collect one or more measurements comprises obtaining contact measurements indicative of the location.

17. The method of claim 13, wherein operating the one or more additional tools comprises operating a wear bushing tool, a casing hanger tool, a blowout preventer (BOP) tool, or any combination thereof, of the downhole tool.

18. A system, comprising:
a downhole tool configured to run into a wellhead of a resource extraction system, wherein the downhole tool comprises:
a lockdown elevation measurement tool configured to collect one or more measurements indicative of a location of one or more lockdown grooves within the wellhead above an uppermost casing hanger in the wellhead, wherein the one or more lockdown grooves are configured to engage a lock of a tubing hanger in a subsequent tubing hanger installation, wherein the lockdown elevation measurement tool comprises a non-contact tool having one or more measurement devices configured to obtain the one or more measurements indicative of the location to determine a distance from the uppermost casing hanger to the one or more lockdown grooves; and
a controller having a processor, a memory, and instructions stored on the memory and executable by the processor to:
receive measurement data of the one or more measurements indicative of the location of the one or more lockdown grooves; and
determine the distance based on the measurement data.

19. The system of claim 18, wherein the one or more measurement devices comprises an optical measurement tool, a magnetic measurement tool, a wireless signal tool, an imaging tool or camera, or any combination thereof.

20. The system of claim 19, wherein the lockdown elevation measurement tool comprises one or more landing detectors configured to detect a landing of the downhole tool on the uppermost casing hanger in the wellhead, wherein the controller is configured to initiate the one or more measurements in response to detection of the landing.
